(19) United States
(12) Patent Application Publication
(10) Pub. No.: US 2005/0105007 A1
(43) Pub. Date: May 19, 2005

(54) Interchangeable media input cartridge for home entertainment

(76) Inventor: John P. Christian, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/714,182

(22) Filed: Nov. 14, 2003

(51) Int. Cl. H04N 5/50

(52) U.S. Cl. 348/731; 348/836

(57) ABSTRACT

In one embodiment, a tuner cartridge has a tuner to demodulate video signals, a first bus connector to receive modulated signals and supply the modulated signals to the tuner, and a second bus connector to send baseband signals received from the tuner. In another embodiment, a tuner system has a slot to receive a tuner cartridge, a baseband bus to connect to a tuner cartridge in the slot, and a source bus to connect to a tuner cartridge in the slot and to supply modulated video signals to a tuner cartridge in the slot.

### BACKGROUND

The present invention relates to the field of tuning broadcast and multicast signals and, in particular, to an interchangeable tuner and slot for consumer receiver equipment.

Many current televisions, personal video recorders (PVR), video tape recorders (VTR), audio/video receivers, media centers, and similar equipment incorporate video and audio tuners. Such tuners are used for displaying, recording and tracking functions.

The number and types of tuners in any particular device may vary greatly. First, there are many different types of tuners that may be desired. Signals from terrestrial radio broadcast, cable broadcast, satellite, optic fiber and wide area networks can all use different carrier frequencies, modulation schemes and encoding. All of these sources may also provide either or both of analog or digital encoded signals. In addition, audio sources, such as AM (Amplitude Modulation) and FM (Frequency Modulation) or satellite radio can use still different signaling and encoding conventions. Further, some programming transport media or signal carriers can support two-way communications or multiple functions. NTSC (National Television Standards Committee) television signals are broadcast as receive only signals, while television coaxial cable may be used for two-way messaging, two-way broadband internet access or telephony.

Second, the standards for radio, television and other multimedia programming change over time and new standards are added. The NTSC standards have been modified in the past to add color pictures, stereo, secondary audio program, closed captioning for the hearing impaired and more. The standards for digital high definition cable television in the United States were put into use only in 2003 and changes are inevitable. Even the standards for FM radio have been changed to add RDS (Radio Data System). A television, PVR, VTR, A/V receiver, or media center may become obsolete only because its tuner has been outdated by a change in the broadcast or multicast standards.

Third, the number of tuners desired for any particular piece of equipment can vary depending on the particular functions to be supported and the price point to be reached. For Picture-in-Picture displays and for recording one or more programs while displaying one or more others, a large number of tuners is desired. Additional tuners can also be used to obtain information, such as program guides or news while one or more other programs are being viewed. Because tuners add to the cost, power, and size of a device, the number and types of tuners in any one device is often limited. Even when the number of tuners is limited, different tuners must be provided to meet the needs of different markets, product lines and price points.

Supporting a line of products with different numbers and types of tuners can add greatly to the complexity and the cost of selling and marketing the equipment. It also can lead to compromises which require customers to either forego tuners which they desire or to pay for tuners which they cannot use. When the standards change, customers must replace the entire system.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 is a diagram of a tuner system with tuner slots and a tuner cartridge according to an embodiment of the present invention;

FIG. 2 is a block diagram of a tuner cartridge and tuner system connectors according to an embodiment of the present invention;

FIG. 3 is a block diagram of a media center suitable for implementing an embodiment of the present invention; and

FIG. 4 is a block diagram of an entertainment system suitable for use with the present invention.

### DETAILED DESCRIPTION

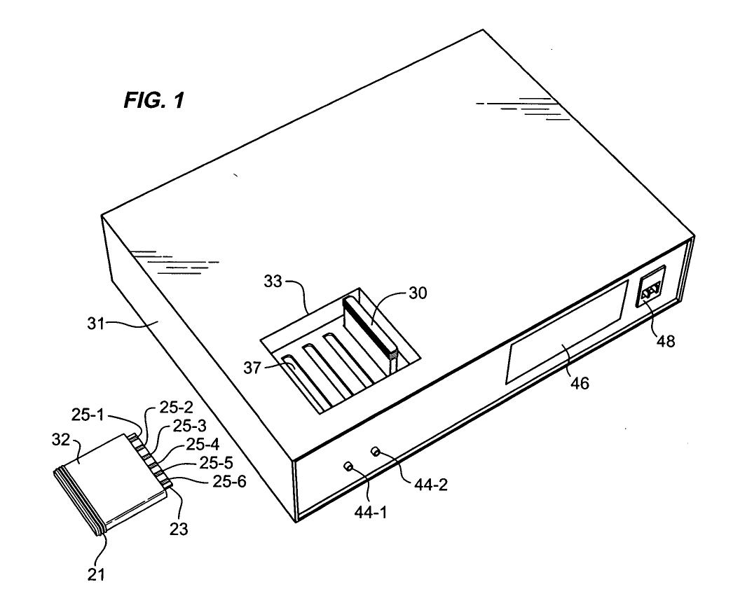

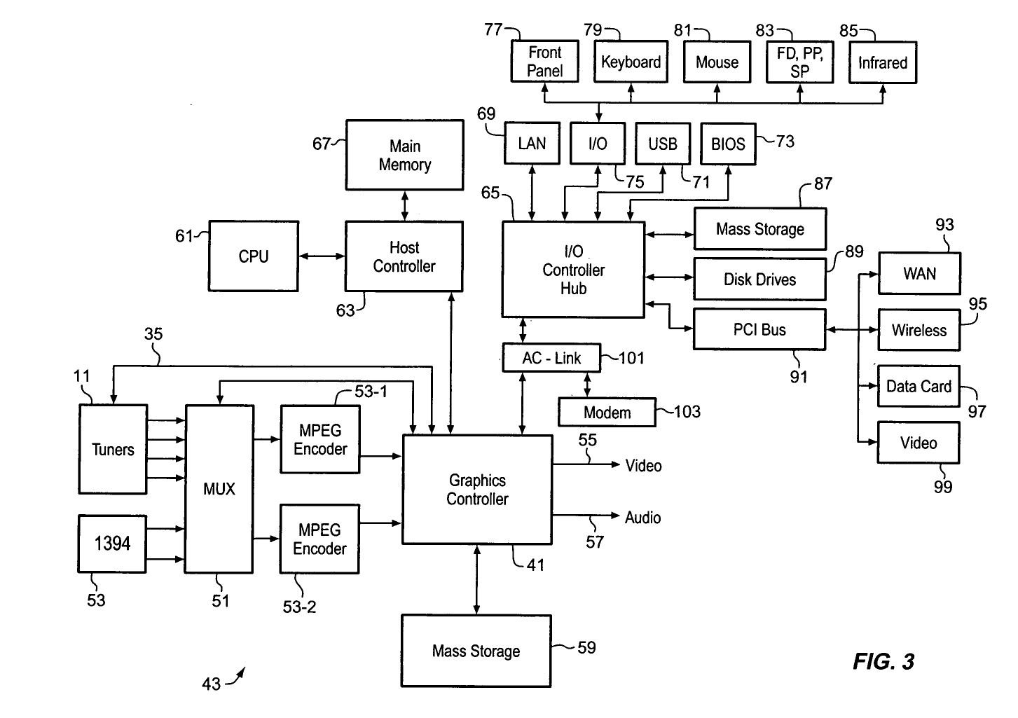

Referring to FIG. 1, a tuner system 31 has a compartment 33 filled with slots 37 for receiving tuner cartridges 32. One cartridge 32 is shown uninstalled and another cartridge 30 is shown installed. The tuner system may be a television or video display, a video or audio recorder, a peripheral device for a computer, a discrete tuner for connection to an entertainment system or any of a variety of other devices including, for example, all or part of the media center of FIG. 3. The device may be a set-top box or it may, for example, be integrated into a television, recorder, or computer. In this example, the tuner system includes set of source connectors 44-1, 44-2, such as F-type coaxial RF (Radio Frequency) cable or antenna connectors, a connection panel 46 for other input and output connectors (not shown), and a power cord connector 48.

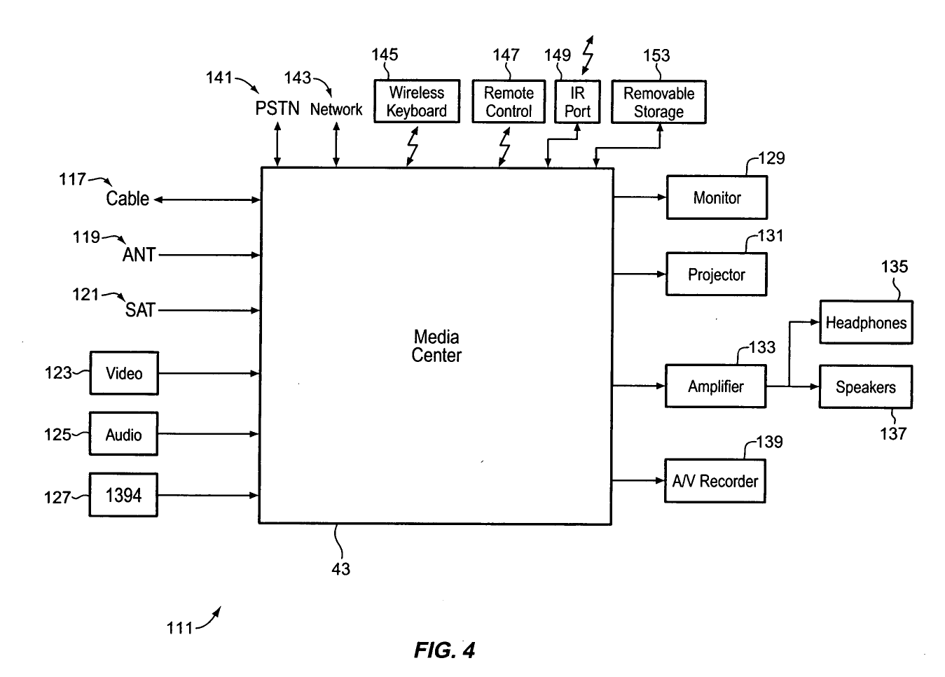

The source connectors may be of the same or different types. Any type of connector, including RF antenna connectors may be used. In addition, the antenna connector may be used to receive other types of signals, such as baseband bitstream or analog signals, composite or component video signals etc. Accordingly, the connectors may be varied to suit the particular application. The connection panel may receive signals from other components and provide signals for displaying or recording. Several examples of such connectors are described with reference to FIGS. 3 and 4.

The slots 37 in the tuner system are adapted to receive tuner cartridges 31. The tuner cartridges may be provided in any of a variety of different forms. In FIG. 1, the tuner cartridge 31 has a closed exterior housing with a connector card edge 23 at one end. The connector card edge in this example is constructed from an end of a printed circuit board (PCB) and has metallic wire connection pads or fingers 25-1 to 25-6 formed on the PCB substrate. The fingers slide into corresponding pads in the slot to make the connection. Such a connection is similar to how interchangeable video game cartridges, computer adapter cards, PC (Personal Computer) add-in cards, and many other types of interchangeable components connect. The particular type of connection is not essential to the present invention however. Any type of connection, electrical, RF, inductive or otherwise may be used with any of a variety of different physical and mechanical designs.

The tuner cartridge also includes ribs 21 to allow a consumer to firmly grip the cartridge as it is being inserted into or removed from the slot. The configuration of FIG. 1 allows a consumer to easily add, remove or share tuner cartridges in the same way that video game cartridges may be added, removed or shared. A cartridge of the type shown may be easily packaged and sold as a stand-alone item. In one marketing approach, the tuner system may be packaged with one standard tuner cartridge, such as an NTSC or PAL cartridge, and then the consumer may be invited to purchase as many additional cartridges as the tuner system can accommodate. When standards are changed or new services, e.g. digital terrestrial broadcast radio, become available, a new or replacement tuner cartridge can be purchased to receive the new or updated service. Alternatively, or in addition, some particularly popular or common tuners may be integrated into the tuner system. So, for example, one or two NTSC tuners may be integrated into the tuner system so that all of the slots are available for more or other types of tuners. For a direct broadcast satellite tuner, the slots may be offered to allow additional signals to be received.

The tuner cartridge compartment 33 shown in FIG. 1 includes spring loaded slot covers to protect from dust, damage, and for safety. The slot covers are keyed with a “D” shape to ensure that cards are inserted in the proper direction. The particular physical configuration shown in FIG. 1 is not essential to the invention. The covers may be attached with screws or special fasteners so that the tuner cartridges are more likely to be added, removed, or replaced by a service technician or dealer. Alternatively, the slots may be left uncovered or a single cover may be used to cover all the slots. The tuner cartridges may be provided without protective covers and gripping surfaces. The tuner cartridges may be provided in a configuration that resembles a PCI (Personal Computer Interface), AGP (Accelerated Graphics Port), PCMCIA (Personal Computer Memory Card International Association), or SD (Secure Digital) card, among others.

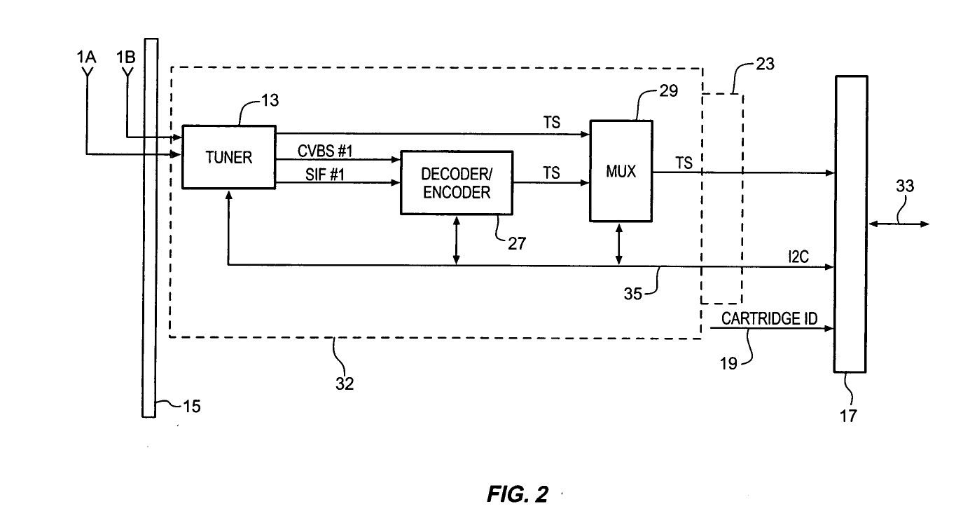

Referring to FIG. 2, the tuner cartridge 32 of FIG. 1 contains at least one video tuner 13. The tuner may be for any one of a variety of different analog and digital television signals, whether broadcast, multicast or point-to-point. Examples include NTSC signals, ATSC (Advanced Television Systems Committee) signals, PAL (Phase Alternating Line) signals, cable television signals under the variety of possible standards, DBS (Direct Broadcast Satellite) signals, FM (Frequency Modulation) or AM (Amplitude Modulation) radio signals, satellite radio signals or any other type of video or audio signal. In the present example, the tuner is coupled to a television coaxial cable, a terrestrial broadcast antenna, or a satellite dish antenna through an F-type coaxial connector 44-1, 44-2 and create an encoded signal for application to other components. The exact nature of the preferred output signal will depend on the particular device.

Alternatively, the tuner may be a composite video tuner. Such a cartridge may allow the system to receive video and audio signals from a video recorder, camera, external tuner, or any other device. With a television monitor, the composite video tuner may allow the monitor to easily be switched from a digital cable broadcast to a home movie being played on a connected video camera. Picture-in-Picture and many other features may also be supported. A great variety of different connectors may be used for this tuner from coaxial cables to RCA component video, S-Video, DIN connectors, DVI (digital video interface), HDMI (High Definition Multimedia Interface), VGA (Video Graphics Adapter), and more. These connectors may be provided on the tuner card or provided through the bus in the tuner slot.

The tuner may alternatively be an FM radio tuner or an AM radio tuner coupled to the same or different antennas. The radio tuner generates an analog audio output that may also be converted in separate analog to digital conversion codecs (not shown) to digital I²S (Inter-IC Sound, an audio bus designed by Phillips Semiconductors) audio signals. If the signals contain RDS (Radio Data System), PTY (Program Type) data, or other embedded or sideband data, this data may be extracted and rendered as video or in some other way to the larger system.

The tuner may alternatively contain a DBS tuner or any other type of satellite tuner coupled to a satellite antenna. The DBS tuner produces a digital MPEG-2 output that may be transmitted directly to the larger system. Analog satellite systems may be accommodated in the same way as the analog terrestrial broadcast tuners described above.

In addition, a tuner cartridge may be provided to receive video signals using a digital host or server connection using any one or more electronic communications interfaces including USB (Universal Serial Bus), Firewire, IDE (Integrated Device Electronics), Ethernet, etc. The tuner cartridge may receive data packets using a communications interface and convert them to a conventional video format or supply them directly to a processor, such as graphics processor 41. Similarly, wireless electronics communications interfaces can be provided in a tuner cartridge, such as Bluetooth, WiFi, GPRS (GSM Packet Radio Service) and others. Any one or more of the tuner cartridges mentioned herein may receive the modulated or packetized data from the bus in the cartridge slot or through specific connectors in the cartridge.

The tuned analog signals are applied to a decoder 27 to convert the analog output to a digital television video signal, such as an ITU-R BT 656 (International Telecommunications Union-Radiocommunications sector standard for digital video) or any other type of video signal. The audio portion may be sampled and converted to digital sound, such as I²S (Inter-IC Sound, a type of bus designed by Phillips Semiconductors to carry digital audio) or any other type of audio signal. Converting the analog signals to digital video and audio allows the resulting video to be handled in a similar way to the MPEG-2 signals from digital tuners. The digitized analog signals are directed from the encoder to a multiplexer 29.

The tuned digital signals from the tuner are routed directly to the multiplexer without being decoded or encoded. This allows digital and analog signals to be handled in the same way by the tuner and larger system. The multiplexer is coupled to the I²C bus to select appropriate outputs and inputs from the tuner. The analog to digital conversion is not necessary to the invention. Signals may be processed and switched in analog form, all signals may be left in their respective native form, or digital signals may be converted to analog signals. As an alternative, any signal conversion may be performed within the greater system. The tuner cartridge of FIG. 1 is shown as an example only.

In addition, a cartridge ID 19 may be provided to the connector of each slot. The cartridge ID may be a unique ID that is encoded into each cartridge. To provide a simpler address, the cartridge ID may alternatively be hardwired into each slot. One or more pins of the slot connector may be shorted high or low to create a fixed ID for each slot. The cartridge may learn its ID by polling the relevant pins or in some other way. The cartridge ID may be used to allow the I²C bus to address each tuner cartridge individually.

The tuner slots contain connections for two types of signaling. In the example of FIG. 2, there is a source bus 15 and a baseband bus 17. The source bus connects signals from antennas to each tuner cartridge. In one example, the signals from the two F-type connectors may be coupled to respective RF splitters that are, in turn, coupled to the connector pads of the slot. This allows the tuner to receive either one or both of two different antenna signals. For example, one antenna may be for digital broadcasts and the other for analog broadcasts. One antenna may be for terrestrial broadcasts and the other for satellite broadcasts. One antenna may be for wireless reception and the other for wired reception. Different connections may be provided depending on the tuners that are used.

The baseband bus 17 couples the output video signals to the larger system and also allows for power supply connection as well as for command and control signals to be communicated between the tuner cartridges and the larger system through a data line 33 to a controller 41 (shown in FIG. 3). The data line may also be used as a control line to allow the controller to send and receive messages to and from the decoders and the tuners. In one embodiment, the tuners are on a daisy-chained I²C (Inter-Integrated Circuit, a type of bus designed by Phillips Semiconductors to connect integrated circuits) control bus 33 which allows the controller to address each tuner individually at any time using assigned addresses, however, any other communications interface or protocol may be used.

The controller may be designed with a unique device-specific interface for each tuner or it may operate through I/O interfaces with some or all of the tuners. Alternatively another standardized I/O interface, such as USB (Universal Serial Bus) or IEEE 1394 (Institute of Electronics and Electrical Engineers standard for high speed serial I/O communications). It may also be a radio connection using any number of different protocols.

For some tuners, there may be additional functions to be supported. For example, some cable and satellite systems require a telephone connection to the PSTN (Public Switched Telephone Network) or to the Internet in order to process billing and subscription information or to order pay-per-view events. Some cable systems use a return signal to the cable head end for the same purpose. Some consumer electronic devices, such as video recorders have a supplemental control connection for commands or timing information. There are also external sources of electronic programming guide (EPG) or station information that may be obtained from dial-up services or from the Internet. Any one or more of these services may use modems in the tuner module cartridges or peripheral devices that are also daisy-chained to the control line 33. For modems in the tuner cartridge, a specific connector (not shown) may be provided on the tuner cartridge.

These additional communications and security functions may also be managed over the bus by the graphics controller so that peripheral devices that are coupled to other buses may be used. For example, if a viewer wishes to order a particular movie, the graphics controller may issue a command to the tuner which may respond that it requires access to its dial-up ordering service. The tuner may either address a modem external to the tuner cartridge directly or address it through the graphics controller.

Identity, billing and subscription cards may be handled in a similar way. Some systems require a special removable card, such as a smart card or access card, in order to decrypt received signals. The smart card slot may be provided for in the tuner cartridge or provided in some other location and coupled over the baseband bus or another bus.

FIG. 3 shows a block diagram of a media center 43 suitable for using the tuner cartridges described above. In FIG. 3, a tuner module 11 is coupled to the graphics controller using e.g. an I²C interface as described above. The graphics controller may be implemented using any of a variety of different processors or ASICs. Some examples include the ST Microelectronics® Sti70 15/20, the Zoran^{a} TL8xx, or Generation 9, and the ATi® Technologies Xilleon™ lines of processors. The graphics controller may be the central processor for the larger system or coupled to a separate CPU, as shown in FIG. 3.

The tuner module 11 may be viewed as including the tuner cartridges, tuner slots, source bus and baseband bus described with respect to FIGS. 1 and 2. The multiple video and audio outputs from the baseband bus described with respect to FIG. 2 are coupled to a multiplexer 51. Other sources may also be coupled to the multiplexer, if desired, for example an IEEE 1394 appliance 53 is shown as also being coupled to the multiplexer. Some such devices might include, tape players, disk players and MP3 players, among others. The multiplexer, under control of the graphics controller selects which of the tuner or other inputs will be connected to the rest of the media center.

The selected tuner inputs are coupled to the multiplexer outputs. These multiplexer outputs are, in the present example, routed each to respective MPEG-2 encoders 53-1, 53-2 and then to the graphics controller 41. In the case of the digital television, radio, digital cable or satellite signals, the multiplexer may route the signals around the MPEG-2 encoders or disable the encoding process as these signals are already encoded.

From the graphics controller, the video and audio signals may be output for display, storage, or recording. In one embodiment, the graphics controller contains MPEG-2 and MPEG-3 decoders as well as a video signal processor to format video and audio signals for use by the desired appliance and to combine command, control, menu, messaging and other images with the video and audio from the tuners. The graphics controller may drive the entire device or operate only for graphics functions under control of another higher level processor, as described below.

For simplicity, FIG. 3 shows only one video output and one audio output, however, the number and variety of outputs may vary greatly depending on the particular application. If the media center is to function as a tuner, then a single DVI, or component video output, together with a single digital audio output, such as an optical S/PDIF (Sony/Philips Digital Interface) output, may suffice. In the configuration shown, the media center may be used as a tuner with picture-in-picture displays on a monitor or it may be used to record one channel-while showing another. If the media center is to serve more functions then additional audio and video connections may be desired of one or more different types.

The actual connectors and formats for the video and audio connections may be of many different types and in different numbers. Some connector formats include coaxial cable, RCA composite video, S-Video, component video, DIN (Deutsche Industrie Norm) connectors, DVI (digital video interface), HDMI (High Definition Multimedia Interface), VGA (Video Graphics Adapter), and even USB and IEEE 1394. There are also several different proprietary connectors which may be preferred for particular applications. The types of connectors may be modified to suit a particular application or as different connectors become adopted.

The media center may also include a mass storage device, such as a hard disk drive, a volatile memory, a tape drive (e.g. for a VTR) or an optical drive. This may be used to store instructions for the graphics controller, to maintain an EPG (Electronic Program Guide) or to record audio or video received from the tuner module.

While the components described above are sufficient for many consumer electronics, home entertainment and home theater devices, such as tuners (terrestrial, cable, and satellite set-top boxes), VTR's, PVR's, and televisions, among others. Further functionality may be provided using some of the additional components described below. In addition, preamplifier and power amplifiers, control panels, or displays (not shown) may be coupled to the graphics controller as desired.

The media center may also include a CPU (Central Processing Unit) 61 coupled to a host controller 63 or chipset. Any number of different CPU's and chipsets may be used. In one embodiment a Mobile Intel® Celeron® processor with an Intel® 830 chipset is used, however the invention is not so limited. It offers more than sufficient processing power, connectivity and power saving modes. The host processor has a north bridge coupled to an I/O controller hub (ICH) 65, such as an Intel® FW82801DB (ICH4), and a south bridge coupled to on-board memory 67, such as RAM (Random Access Memory). The chipset also has an interface to couple with the graphics controller 41. Note that the invention is not limited to the particular choice of processor suggested herein.

The ICH 65 offers connectivity to a wide range of different devices. Well-established conventions and protocols may be used for these connections. The connections may include a LAN (Local Area Network) port 69, a USB hub 71, and a local BIOS (Basic Input/Output System) flash memory 73. A SIO (Super Input/Output) port 75 may provide connectivity for a front panel 77 with buttons and a display, a keyboard 79, a mouse 81, and infrared devices 85, such as IR blasters or remote control sensors. The I/O port may also support floppy disk, parallel port, and serial port connections. Alternatively, any one or more of these devices may be supported from a USB, PCI or any other type of bus.

The ICH may also provide an IDE (Integrated Device Electronics) bus for connections to disk drives 87, 89 or other large memory devices. The mass storage may include hard disk drives and optical drives. So, for example, software programs, user data, EPG data and recorded entertainment programming may be stored on a hard disk drive or other drive. In addition CD's (Compact Disk), DVD's (Digital Versatile Disk) and other storage media may be played on drives coupled to the IDE bus.

A PCI (Peripheral Component Interconnect) bus 91 is coupled to the ICH and allows a wide range of devices and ports to be coupled to the ICH. The examples in FIG. 3 include a WAN (Wide Area Network) port 93, a Wireless port 95, a data card connector 97, and a video adapter card 99. There are many more devices available for connection to a PCI port and many more possible functions. The PCI devices may allow for connections to local equipment, such as cameras, memory cards, telephones, PDA's (Personal Digital Assistant), or nearby computers. They may also allow for connection to various peripherals, such as printers, scanners, recorders, displays and more. They may also allow for wired or wireless connections to more remote equipment or any of a number of different interfaces. The remote equipment may allow for communication of programming or EPG data, for maintenance or remote control or for gaming, Internet surfing or other capabilities.

Finally, the ICH is shown with an AC-Link (Audio Codec Link) 101, a digital link that supports codecs with independent functions for audio and modem. In the audio section, microphone input and left and right audio channels are supported. In the example of FIG. 3, the AC-Link supports a modem 103 for connection to the PSTN, as well as an audio link to the graphics controller 41. The AC-Link carries any audio generated by the CPU, Host Controller or ICH to the graphics controller for integration with the audio output 57. Alternatively, an ISA (Industry Standard Architecture) bus, PCI bus or any other type connection may be used for this purpose. As can be seen from FIG. 3, there are many different ways to support the signals produced by the tuner and to control the operation of the tuners. The architecture of FIG. 3 allows for a wide range of different functions and capabilities. The particular design will depend on the particular application.

FIG. 4 shows a block diagram of an entertainment system 111 suitable for use with the media center of FIG. 3. FIG. 4 shows an entertainment system with a wide range of installed equipment. This equipment is shown as examples of many of the possibilities. The present invention may be used in a much simpler or still more complex system. The media center as described in FIG. 3, is able to support communication through WAN and LAN connections, Bluetooth, IEEE 802.11 USB, 1394, IDE, PCI, and Infrared. In addition, the tuner module receives inputs from antennas, component, and composite video and audio and IEEE 1394 devices. This provides extreme flexibility and variety in the types of devices that may be connected and operate with the media center. Other interfaces may be added or substituted for those described as new interfaces are developed and according to the particular application for the media center. Many of the connections may be removed to reduce cost. The specific devices, shown in FIG. 4 represent one example of a configuration that may be suitable for a consumer home entertainment system.

The media center 43 has several different possible inputs as described above. In the example of FIG. 4, these include a television cable 117, a broadcast antenna 119, a satellite receiver 121, a video player 123, such as a tape or disk player, an audio player 125, such as a tape, disk or memory player, and a digital device 127, connected for example by an IEEE 1394 connection.

These inputs, after processing, selection and control may be used to generate outputs for a user. The outputs may be rendered on a monitor 129, or projector 131, or any other kind of perceivable video display. The audio portion may be routed through an amplifier 133, such as an A/V receiver or a sound processing engine, to headphones 135, speakers 137 or any other type of sound generation device. The outputs may also be sent to an external recorder 139, such as a VTR, PVR, CD or DVD recorder, memory card etc.

The media center also provides connectivity to external devices through, for example a telephone port 141 and a network port 143. The user interface is provided through, for example, a keyboard 145, or a remote control 147 and the media center may communicate with other devices through its own infrared port 149. A removable storage device 153 may allow for MP3 compressed audio to be stored and played later on a portable device or for camera images to be displayed on the monitor 129.

There are many different equipment configurations for the entertainment center using the media center of FIG. 3 and many different possible choices of equipment to connect. A typical home entertainment system, using typical currently available equipment, might be as follows. As inputs, this typical home entertainment system might have a television antenna 119 and either a cable television 117 or DBS 121 input to the tuner module of the media center. A VTR or DVD recorder might be connected as an input device 123 and an output device 139. A CD player 125 and an MP3 player 127 might be added for music. Such a system might also include a wide screen high definition television 129, and a surround sound receiver 133 coupled to six or eight speakers 137. This same user system would have a small remote control 147 for the user and offer remote control 149 from the media center to the television, receiver, VTR, and CD player. An Internet connection 141 and keyboard 145 would allow for web surfing, upgrades and information downloads, while a computer network would allow for file swapping and remote control from or to a personal computer in the house.

It is to be appreciated that a lesser or more equipped tuner cartridge, tuner module, entertainment system and media center than the examples described above may be preferred for certain implementations. Therefore, the configuration of the entertainment system, media center, and components will vary from implementation to implementation depending upon numerous factors, such as price constraints, performance requirements, technological improvements, or other circumstances. Embodiments of the invention may also be applied to other types of software-driven systems that use different hardware architectures than that shown in FIGS. 1,2, 3 and 4.

In the description above, for purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various steps. The steps of the present invention may be performed by hardware components, such as those shown in FIGS. 1, 2, 3, and 4, or may be embodied in machine-executable instructions, which may be used to cause general-purpose or special-purpose processor or logic circuits programmed with the instructions to perform the steps. Alternatively, the steps may be performed by a combination of hardware and software.

Many of the methods and apparatus are described in their most basic form but steps may be added to or deleted from any of the methods and components may be added or subtracted from any of the described apparatus without departing from the basic scope of the present invention. It will be apparent to those skilled in the art that many further modifications and adaptations may be made. The particular embodiments are not provided to limit the invention but to illustrate it. The scope of the present invention is not to be determined by the specific examples provided above but only by the claims below.

1. A tuner cartridge comprising:
a tuner to demodulate video signals;
a first bus connector to receive modulated signals and supply the modulated signals to the tuner; and
a second bus connector to send baseband signals received from the tuner.

2. The cartridge of claim 1, wherein the first bus connector couples to a first bus of a tuner system, the first bus being a radio frequency bus.

3. The cartridge of claim 1, wherein the second bus connector couples to a second bus of a tuner system, the second bus being a baseband bus.

4. The cartridge of claim 1, wherein the second bus connector further communicates power, command and control signals.

5. The cartridge of claim 2, wherein the first bus connector and the second bus connector are formed in a printed circuit board substrate including electrical connectors formed of conductive leads on the substrate to connect to first and second buses of a tuner system.

6. The cartridge of claim 1, further comprising fingers at an end of the cartridge to carry the first bus connector and the second bus connector.

7. The cartridge of claim 1, further comprising an encoder coupled between the tuner and the second bus connector to decode signals demodulated by the tuner.

8. The cartridge of claim 1, further comprising a housing to enclose the tuner and to carry the first bus connector and the second bus connector.

9. A tuner cartridge comprising:
a tuner to demodulate radio frequency modulated video signals;
a housing to enclose the tuner;
a connector card edge protruding from an end of the housing to engage a slot in a tuner system; and
fingers on the connector card edge to connect to a bus in the tuner system when the card edge is engaged in the slot.

10. The cartridge of claim 9, further comprising a gripping surface to allow the cartridge to be inserted into and removed from a tuner system.

11. The cartridge of claim 9, wherein the fingers comprise a plurality of electrical connectors to communicate power, command and control signals with the baseband bus.

12. The cartridge of claim 9, wherein the fingers comprise a plurality of connectors to receive modulated video signals from a source bus in the tuner system.

13. The cartridge of claim 9, wherein the fingers comprise a plurality of connectors to send demodulated video signals to a baseband bus in the tuner system.

14. The cartridge of claim 10, wherein the connector card edge comprises a printed circuit board substrate and wherein the fingers comprise conductive leads on the substrate.

15. A tuner system comprising:
a slot to receive a tuner cartridge;
a baseband bus to connect to a tuner cartridge in the slot; and
a source bus to connect to a tuner cartridge in the slot and to supply modulated video signals to a tuner cartridge in the slot.

16. The system of claim 9, wherein the baseband bus receives demodulated video signals from a tuner cartridge in the slot.

17. The system of claim 1, wherein the baseband bus communicates power, command and control to a tuner cartridge in the slot.

18. The system of claim 9, wherein the slot comprises electrical connectors to mate with corresponding electrical connectors of a tuner cartridge to provide a connection the baseband bus.

19. The system of claim 9, further comprising a source connector to connect to a source of modulated video signals and to the source bus.

20. The system of claim 13, further comprising a plurality of slots and wherein the source bus comprises a splitter to couple a tuner cartridge in a plurality of slots to the source connector.

21. The system of claim 13, wherein the source connector comprises a coaxial cable connector to receive video signals from an antenna.

22. The system of claim 9, further comprising a video output connector to provide video signals from the baseband bus to a video device.

23. The system of claim 9, further comprising a video processor coupled between the baseband bus and the video output connector to generate a video signal for the video device.

24. A consumer entertainment system comprising:
a slot to receive a tuner cartridge;
a baseband bus to connect to a tuner cartridge in the slot;
a video processor coupled to the baseband bus to generate a video signal at the video output connector for a video device; and
a source bus to connect to a tuner cartridge in the slot and to supply modulated video signals to a tuner cartridge in the slot.

25. The system of claim 24, wherein the baseband bus receives demodulated video signals from a tuner cartridge in the slot.

26. The system of claim 24, wherein the baseband bus communicates power, command and control to a tuner cartridge in the slot.

27. The system of claim 13, further comprising a plurality of slots and a source connector to connect to a source of modulated video signals and to the source bus, and wherein the source bus comprises a splitter to couple a tuner cartridge in a plurality of slots to the source connector.
